(19) United States
(12) Patent Application Publication
(10) Pub. No.: US 2011/0191626 A1
(43) Pub. Date: Aug. 4, 2011

(54) Fault-tolerant network management system

(76) Inventors: Mohammed H. Sqalli, Dhahran (SA); Mostafa I. Abd-El-Barr, Dhahran (SA); Louai Al-Awami, Kingston (CA)

(21) Appl. No.: 12/656,505

(22) Filed: Feb. 1, 2010

(51) Int. Cl. G06F 11/20; G06F 17/30; G06F 11/00

(52) U.S. Cl. 714/4.12; 707/610; 714/E11.072; 707/E17.005

(57) ABSTRACT

The fault-tolerant network management system is a hierarchical system having two Manager-of-Managers (MoM) that are implemented at the highest layer in an active-passive mode. A middle layer includes Mid-Level Managers (MLMs), which are used to manage agents disposed throughout different areas of the network at the lowest layer. The MLMs relieve the MoM from dealing with individual agents, and hence enhance the scalability of the whole Network Management Systems. MLMs are configured to work in pairs, where each pair includes two MLMs working in an active-active mode. The MoMs and MLMs have the capability of backing each other up in the case of a failure.

### BACKGROUND OF THE INVENTION

1. Field of the Invention

The present invention relates to network management systems, and more specifically to a fault-tolerant network management system having three hierarchical levels and redundancy.

2. Description of the Related Art

Network management systems (NMSs) have existed for some time now, and their main goal has been to provide ways to monitor and control network elements, such as hosts, servers, switches, routers, and the like, to guarantee some acceptable level of quality for the delivery of networking services. One aspect that has not been well addressed in NMSs is Fault tolerance. Fault tolerance has been addressed in the case of networking infrastructure and services, but not for the management aspects of networks. What is apparently lacking in the art until now is an architecture that addresses the Fault tolerance in NMSs. Fault tolerance is important in managing networks because it allows administrators to rely on NMSs to deliver the right service even when some parts of these systems have failed or are not functioning as expected.

It would be desirable to provide a Fault-Tolerant Network Management System (FTNMS) that provides a robust, reliable, and flexible architecture for the management of networks.

Thus, a fault-tolerant network management system solving the aforementioned problems is desired.

### SUMMARY OF THE INVENTION

The fault-tolerant network management system (FTNMS) has three layers, including two Manager-of-Managers (MoMs) that are implemented at the highest layer in an active-passive mode. In the middle layer, Mid-Level Managers (MLMs) are used to manage different areas of the network comprised of agents (i.e., managed nodes) that exist at the lowest layer (i.e., leaves). The MLMs relieve the MoM from dealing with individual agents and hence enhancing the scalability of the whole Network Management Systems (NMSs). MLMs are configured to work in pairs where each pair contains two MLMs working in an active-active mode. The MoMs and MLMs have the capability of backing up each other in the case of a failure.

The fault-tolerant network management system uses a simple parallel MoM model with an overall reliability of 2R_{MoM-R}²_{MoM}, where R_{MoM} is the reliability of an individual MoM. The expected average value of the overall MoM is 0.67, as compared to 0.5 for a conventional network management system. In addition, the system uses a series-parallel MLM model with an overall reliability of (2R_{MLM}−R²_{MLM})^{m}, where R_{MLM} is the reliability of an individual MLM and m is the number of MLM pairs used. The gain in the overall reliability resulting from the use of the system is given by R_{gain}=[(2−R_{MoM})(2/R_{MLM}−1)^{m}−1] with a typical reliability gain of about 20% when using two MLM pairs. In terms of availability, the fault-tolerant network management system can achieve an availability of about 0.98 with only one pair of MLMs. This is to be compared with an availability of about 0.72 with a comparable hierarchical network management system. It should be noted that the achieved increase in the reliability and availability of the proposed system comes at an affordable cost in terms of the increase in the traffic needed for synchronization among network nodes.

State information is maintained differently at different levels. At the MoMs level, a centralized copy of the state/management information database is maintained by the active MoM. All updates made to the active database are reflected in the backup copy on the passive MoM through a synchronization mechanism. This allows for a central view of the state information without compromising the Fault tolerance capability. Each MLM, on the other hand, maintains its own database, in addition to a copy of the database pertaining to its partner MLM. This allows each MLM to have access to its partner's database when the latter fails and to continue managing on its behalf until it is back online.

The proposed framework provides reliability, availability, centralized control and scalability at an affordable cost. Without any changes to the existing management protocols and management applications, the framework can be integrated with existing network management systems to improve their reliability. Besides, the system allows an easy extension of both a centralized and a hierarchical network management system to a fault-tolerant network management system.

These and other features of the present invention will become readily apparent upon further review of the following specification and drawings.

### BRIEF DESCRIPTION OF THE DRAWINGS

FIG. 1 is a chart showing a hierarchical view of a fault-tolerant network management system according to the present invention.

FIG. 2 is a block diagram showing the network connectivity of a fault-tolerant network management system according to the present invention.

FIG. 3 is a block diagram showing a logical interconnection of MLMs in a fault-tolerant network management system according to the present invention.

FIG. 4 is a block diagram showing normal operation of a fault-tolerant network management system according to the present invention.

FIG. 5 is a block diagram showing MoM2 replacing MoM1 upon failure of MoM1 in a fault-tolerant network management system according to the present invention.

FIG. 6 is a block diagram showing an MLM reporting to the failed MoM1 and being redirected to the new MoM2 when it becomes active in a fault-tolerant network management system according to the current invention.

FIG. 7 is a block diagram showing MLM2 replacing MLM1 upon failure of MLM1 in a fault-tolerant network management system according to the present invention.

FIG. 8 is a block diagram showing an agent reporting to the failed MLM1 and being redirected to the backup MLM2 in a fault-tolerant network management system according to the current invention.

FIG. 9 is a block diagram showing database configuration at the MLM and MoM levels in a fault-tolerant network management system according to the present invention.

Similar reference characters denote corresponding features consistently throughout the attached drawings.

### DETAILED DESCRIPTION OF THE PREFERRED EMBODIMENTS

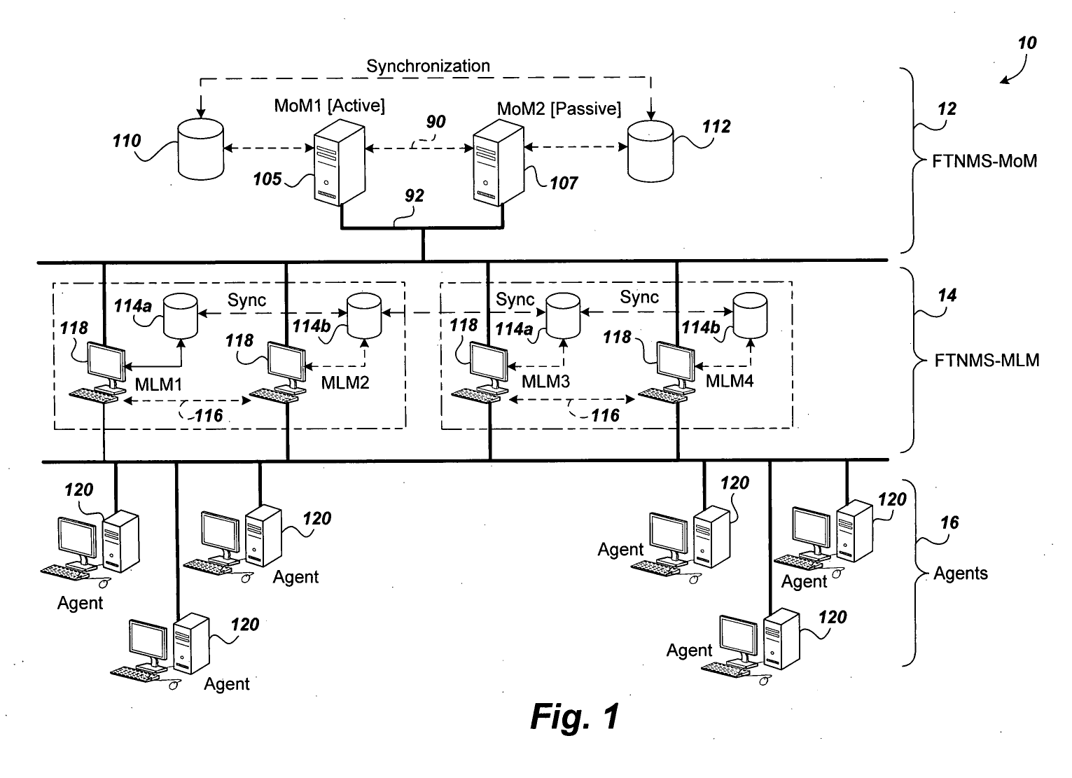

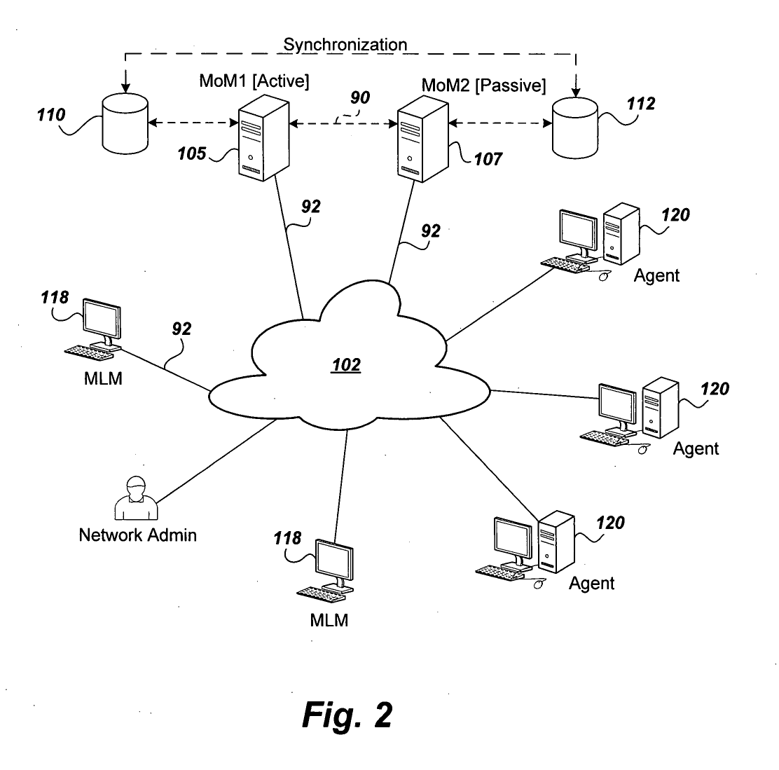

As shown in FIGS. 1-2, the fault-tolerant network management system (FTNMS) 10 has a defined Architecture, Fault tolerance methodology, State/Management Information Operation, and Load Sharing paradigm. The architecture of the FTNMS 10 is represented as a three-layer hierarchical network management system (NMS) comprising a top layer 12 of Manager-of-Managers (MoMs), a middle layer 14 of Mid-Level Managers (MLMs), and a bottom layer 16 of Agents (Leaves). MoMs 105 and 107 supervise MLMs 118, and MLMs 118 supervise network nodes (Agents) 120. A hierarchical and layered NMS has many advantages, such as modularization and predictability. In addition, since topology is limited to three layers, the system 10 is more efficient in terms of response time. In general, there is no need to have more than three layers, even in a hierarchical network topology. Having more layers means more complex management.

In the FTNMS 10, two real addresses are used; one for each Manager-of-Managers (MoM) 105, 107 with one common Floating Virtual IP (VIP) used by whichever of MoMs 105, 107 is currently active. This is useful in providing architectural flexibility. In the FTNMS, the VIP available at both MoMs, and accessible via network connection 92, is the IP that is used to address MoMs in top layer 12 by other entities, such as Middle-Level-Managers (MLMs) 118, agents 120, and network administrators, as shown in FIG. 2. This has the advantage of providing a system's unified view of the MoM layer 12.

In the FTNMS 10, the use of a centralized addressing scheme allows administrators, MLMs 118 and agents 120 to reach the MoM layer 12 using one single IP, regardless of which of the MoMs 105, 107 is active. If the active MoM fails, there is no need to publish the real IP address of the newly active MoM, so there is no extra overhead of publishing IP addresses.

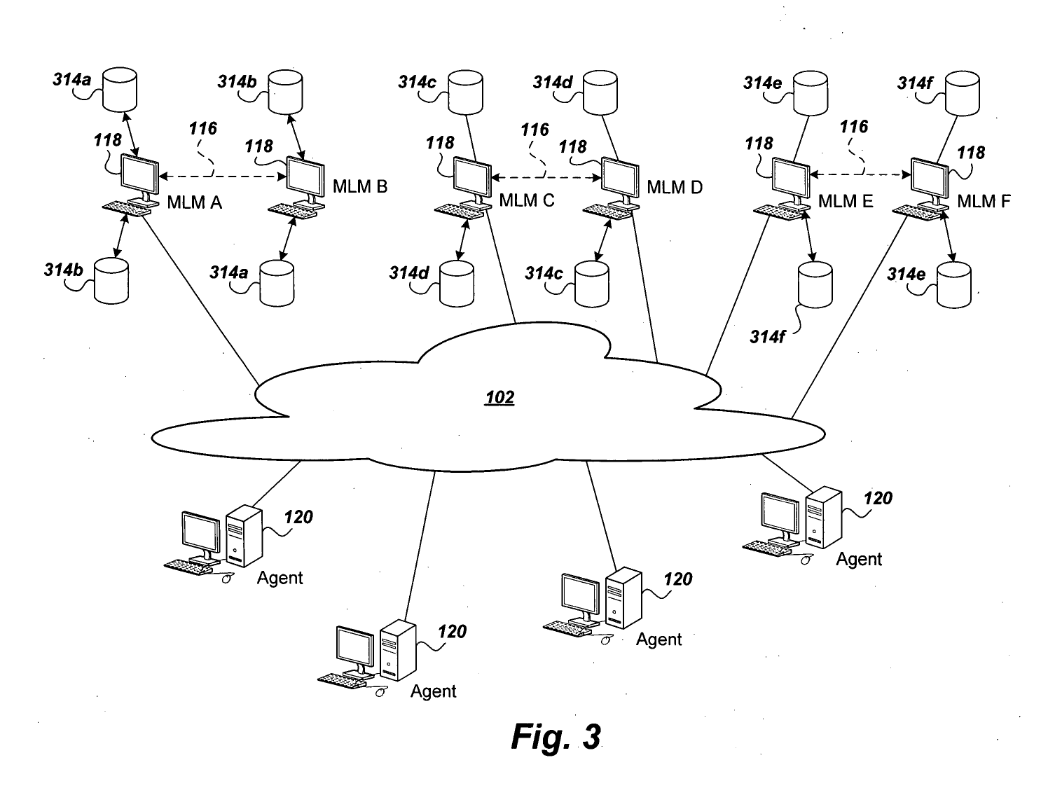

As shown in FIG. 3, for the FTNMS 10, in the mid-layer 14, each pair includes only two MLMs 118 that are backing each other up. The three pairs are MLM A-MLM B, MLM C-MLM D, and MLM E-MLM F. This configuration provides modularity of MLMs 118. In the FTNMS 10, having the MLMs in pairs lowers the bandwidth and space needed to exchange the heartbeats 116, and to synchronize and store the databases 314a-314f. This also saves system resources. The architectural complexity is limited to only an MLM pair for each sub-group, which is more efficient. Agents 120 communicate with the MLMs via the network 102, which may be a local area network (LAN), a wide area network (WAN), the Internet, or any other computer network.

In the FTNMS 10, the role of each manager (MoM or MLM) (active or passive) is decided by the administrator. The advantage of the scheme used in FTNMS 10 is the ease of high level system controllability/flexibility. This gives the control and flexibility to the administrator to decide on the role(s) of each manager. The drawback is that it is a static assignment. This may not be a crucial issue, since the network management topology does not need to change frequently.

In the FTNMS 10, the MoMs 105, 107 are organized in a Hot Standby Sparing Scheme, i.e., as a pair of active/passive managers. This provides the MoM End-to-End Continuity of Service. The FTNMS 10 is efficient, since the spare MoM 107 is already known, thus obviating the requirement of a MoM election.

In the FTNMS 10, each manager is implemented as a holistic, and the role of each such manager is dynamically configurable, i.e., each manager is implemented as a segregated NMS. This is useful, as it provides the NMS with modularity and function reconfigurability. This also provides a modular approach where having a greater or lesser number of managers is possible, as long as they are assigned a specific role in the network management hierarchy.

In the FTNMS 10, the MLMs 118 are grouped to work in a fully functioning Hot Sparing Scheme (active/active), whereby every two MLMs are grouped into a pair of NMSs This provides the MLM End-to-End Continuity of Service. Each MLM 118 has an IP address that is different from, but known to, its pairing MLM, i.e., MLM 1 has an IP address that is different from, but known to MLM 2, and the like. This provides the MLM IP identity preservation. Having only a pair of MLMs in each group means less overhead. The active/active scheme allows for a better use of resources.

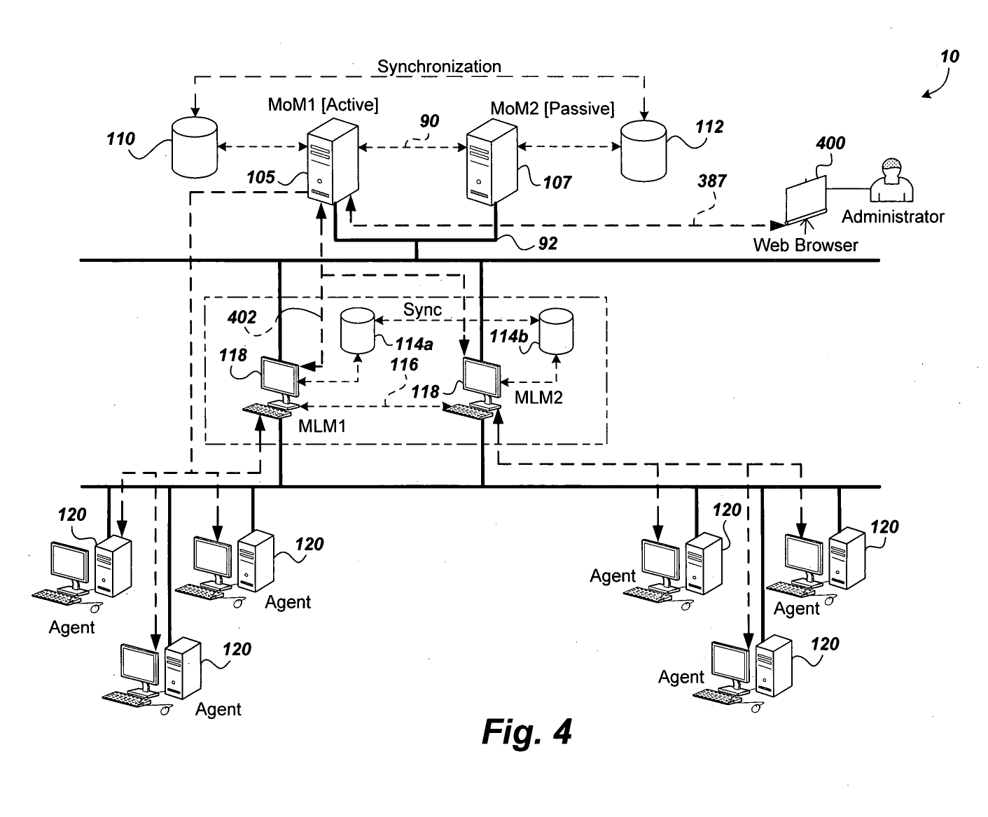

The system 10 uses Dynamic (Active) Hardware Redundancy in building each Manager-of-Managers (MoM). FIG. 4 illustrates the normal operation of the MoM. The arrow paths indicate nominal communication routes between the layers. Note particularly arrow path 402, which connects MLM1 and MLM2 to MoM1.

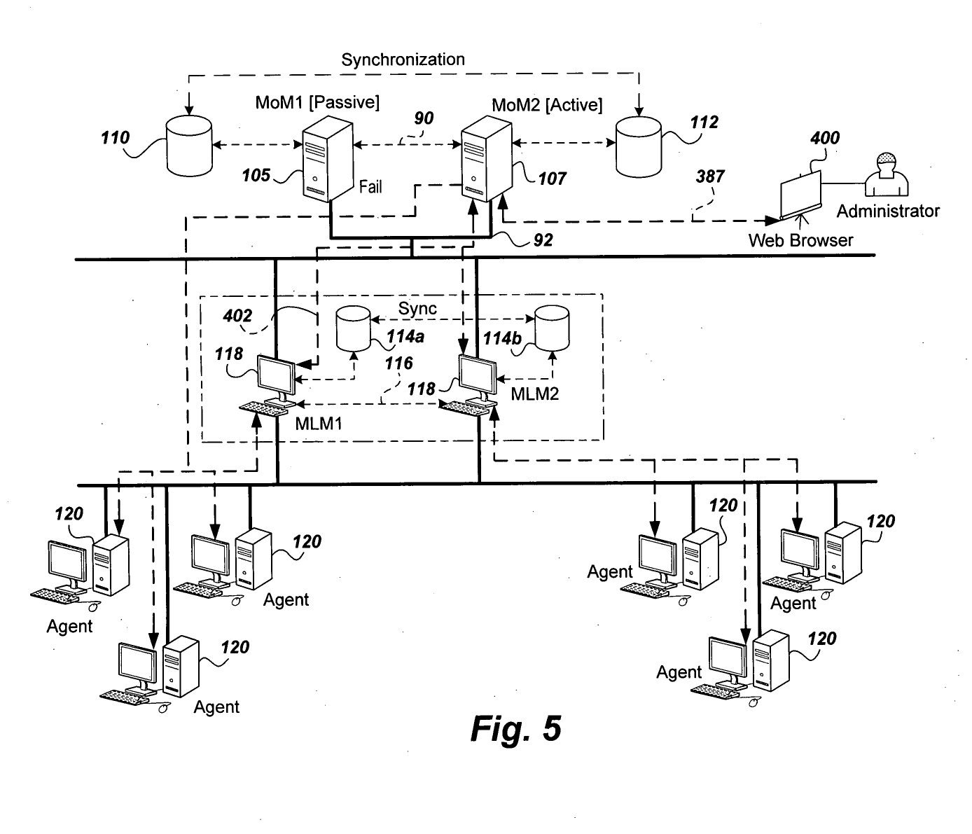

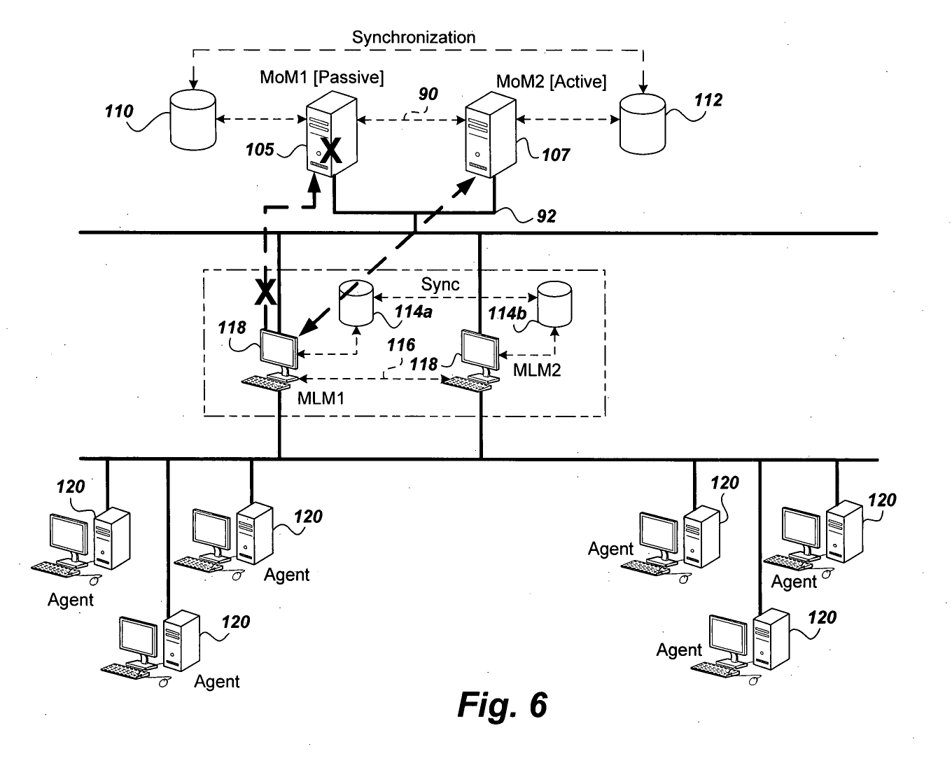

The pair of MoMs 105, 107 is configured after the Hot Standby Sparing Scheme, i.e., as a pair of active/passive managers, with one active MoM 105 and one hot spare MoM 107. The spare MoM 107 keeps listening to heartbeats from the active MoM 105 via heartbeat connection 90 and accordingly synchronizes its database with that of the active MoM. FIG. 5 shows the scenario of an active MoM1 failing and the process leading to its partner MoM2 replacing it. As seen, upon failure of MoM1, MoM2 will assume the Virtual IP (VIP) address and resume monitoring on behalf of MoM1 with no interruption to the services offered. Note that because of Virtual IP (VIP) addressing, the communications path 402 from MoM1 is rerouted to MoM2. FIG. 6 illustrates the case in which an MLM can report to a failed MoM1, but with MoM2 taking over so that there is no adverse impact on the transactions taking place at the time of failure.

The hot standby sparing configuration makes the spare MoM at level 12 always ready to takeover upon failure of the active MoM, and hence leads to a faster switch in the event of failure.

The MoM scheme assumes one (Virtual) IP address, which is accessible via network connection 92, and which is to be used for addressing the MoM pair at level 12 regardless of which of the two MoMs is currently active. Hence, the identity of the currently active MoM is kept hidden from the other entities in the network, such as agents and network administrators. Identity hiding of the currently active MoM also allows for transparent incorporation of the MoM scheme into existing Network Management Systems (NMSs) with minimal (and probably no) modifications. In addition, the VIP addressing scheme used in MoMs 105, 107 allows network designers to fit the proposed FTNMS 10 into existing network protocols with no need for any modifications. Virtual IP addressing allows for the use of a centralized addressing scheme.

The FTNMS 10 fully synchronizes two databases, one by each of the MoMs 105,107. The exemplary active MoM 105 is only allowed to update the database 110, while the exemplary spare MoM 107 receives all database transactions made by the active MoM 105 and incorporates them into its own database 112. This process guarantees data integrity/consistency in the presence of MoM failure.

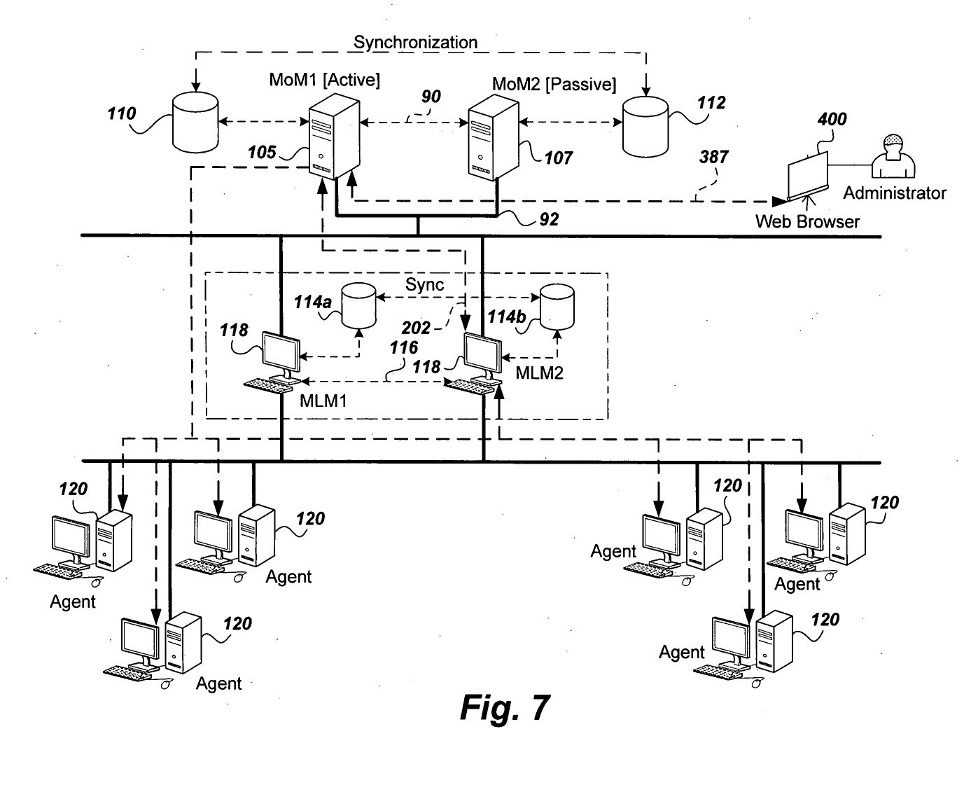

The Mid-Level Managers (MLMs) 118 are grouped into pairs of MLMs configured to operate in a fully functioning Hot Sparing Scheme (active/active mode). Each paired MLM 118 acts as a backup for the other MLM 118 (e.g., MLM1 and MLM2 are mutual backups, MLM3 and MLM4 are mutual backups, etc.). FIG. 3 depicts the logical view of the clusters of MLMs suggested in the FTNMS 10. When an MLM of pairs (A-B, C-D, E-F) fails, the partner of the failed MLM will assume the failed MLMs IP address in a Floating IP arrangement. As shown in FIG. 7, MLM1 can fail and MLM2 can replace MLM1 via data communications path 202 with no impact on the transactions in progress during the failover.

The transparent failover allows for automatic switching to the partner MLM without the need for other entities (such as MoM, agents, and network administrators) in the network to know about and/or be affected by the failure of an MLM 118. This feature leads to continuity of service, with minimal MLM service interruption time, if any.

The use of a floating IP MLM addressing scheme allows network designers to fit the FTNMS 10 into existing network protocols with no need for any modifications.

Each MLM 118 keeps a log of all transactions started by its partner during the failover process. This allows any transaction to be restarted by the MLM that takes over due to the failure of its partner. When a failed MLM is up again, its partner MLM will release the IP address and the database. Therefore, the MLM that failed has all the information it would have collected as if no such failure had happened. Via transaction logging, the FTNMS 10 allows for the use of backward check-pointing, which, in turn, leads to a reduction in the MLM failure recovery time and a guarantee of database integrity/consistency even in the presence of a faulty MLM.

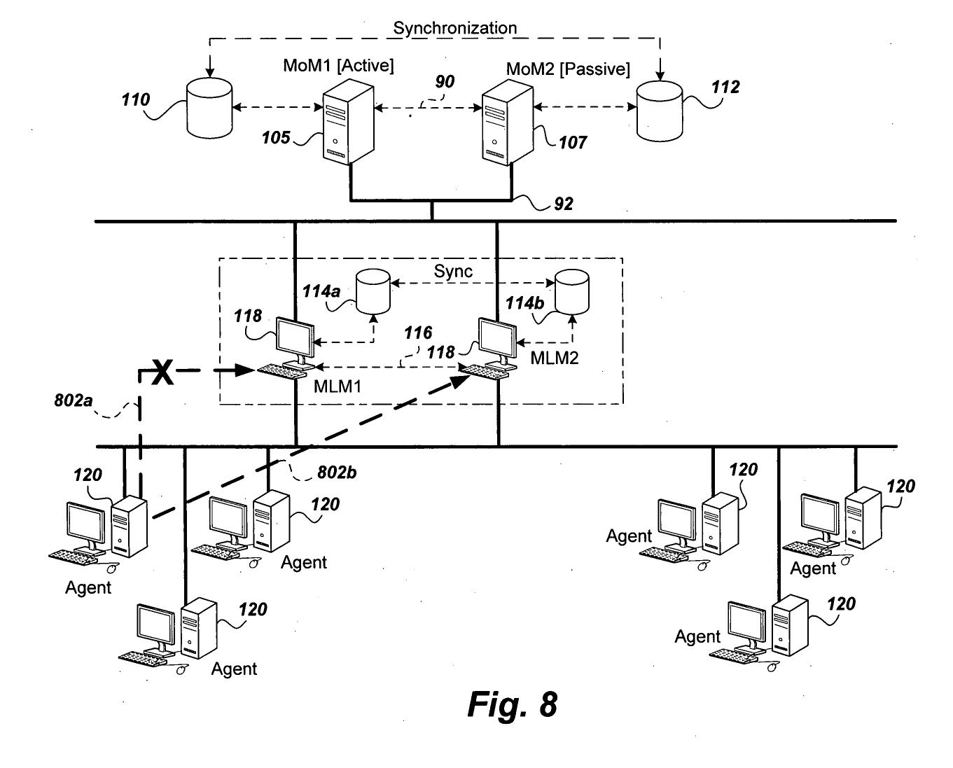

The introduction of MLMs 118 in the FTNMS 10 relieves MoMs 105,107 from monitoring of individual network nodes and delegates such task to the added clusters of MLMs. As shown in FIG. 8, an agent 120 reporting to a failed MLM1 via comm path 802a begins communication with MLM2 via comm path 802b, which takes over with no impact on the transactions in progress. Moreover, the tiered configuration for failover allows for increased scalability of the NMS 10.

The use of fault-tolerant MoMs 105, 107 and MLMs 118 leads to the availability of a backup for every NMS, i.e., the FTNMS 10 is a self-healing/self-recovering NMS.

The use of heartbeat monitoring within MoMs or MLMs sub-groups allows for containment of fault detection within sub-groups, thereby allowing for easy fault identification and/or diagnosis.

The process of a partner MLM managing the agents of the failed MLM results in a transparent failover. This is true while an MLM is collecting information from agents or when agents are sending traps to the MLMs. The FTNMS 10 provides continuous End-to-End Service, even in the presence of a faulty MLM.

The FTNMS 10 guarantees the availability of a most-up-to-date copy of the database at all times. Thus, the management function proceeds unaffected by the failure that may take place in any MoM and/or MLM, thereby allowing fault recovery of any interrupted transaction to take place with minimum (possibly no) interruption to the system.

Grouping of MLMs as shown in FIGS. 1-9 can make up for part of the additional bandwidth needed for heartbeat monitoring and database synchronization.

In order to improve Fault tolerance, the FTNMS 10 features two physical and fully synchronized databases 110 and 112 at the MoMs level and fully synchronized databases 114a and 114b at the MLMs levels.

At the MoM level 12, the passive MoM 107 maintains a copy of the database pertaining to the active MoM 105 through active synchronization between the active and the passive MoMs 105, 107. In addition to normal management information, the active MoM 105 logs all operations before they are started into the database 110, which is directly synchronized with the copy database 112 maintained by the passive MoM 107. In case of failure of the active MoM 105, the passive MoM 107 can restart/resume interrupted operations after assuming the primary (active) role. This guarantees that no information is lost due to a failure and that the management state information reflects the actual state of the network and is consistent and up-to-date.

The existence of two physical databases 110, 112 improves the reliability in case of physical damage, e.g.; hard disk failure. In addition, data integrity and consistency are ensured by allowing only the active manager to modify the database. Changes are transferred to the backup copy on the passive MoM 107 through an active synchronization mechanism. When a MoM recovers from failure, a complete database update can take place using the database of the secondary MoM and the system can continue functioning as if no failure had happened.

In addition to the benefits mentioned earlier, the use of active-passive configuration at the MoM level 12 provides a unified and centralized view of the whole network represented by one database. More specifically, the network administrator can view and control the network utilizing communication line 387, which connects the system to web browser 400, by maintaining only one database residing on one node that they can connect to. This eliminates the need for a complex distributed system without compromising the main goal of building the system that is fault-tolerant.

The hierarchical structure of the FTNMS 10 provides both flexibility and scalability. From the state/management information perspective, MLMs are responsible for controlling different sets of nodes and sending aggregate information to the MoM, relieving the MoM from dealing with single nodes. MLMs 118 send aggregate management information to the active MoM 105 where it gets synchronized with the database 112 of the passive MoM 107 by the synchronization mechanism.

On the MLM level 14, however, as shown in FIG. 3, each MLM 118 maintains two separate databases; one of its own and one representing a backup of its partner MLM's database (databases 314a-314f are the primary and backup databases for their respective MLM pairs). The reason for choosing to have two databases is driven by the fact that nodes within an MLM pair work in an active-active mode, and hence require distinct databases, since each MLM monitors a different set of nodes. Similar to the MoMs, the existence of two physical databases in addition to allowing one node to modify each database at a time ensures both data integrity and consistency at all times. Moreover, restricting the supervision of each node (leaf node) to one MLM assures the integrity of state information of each node.

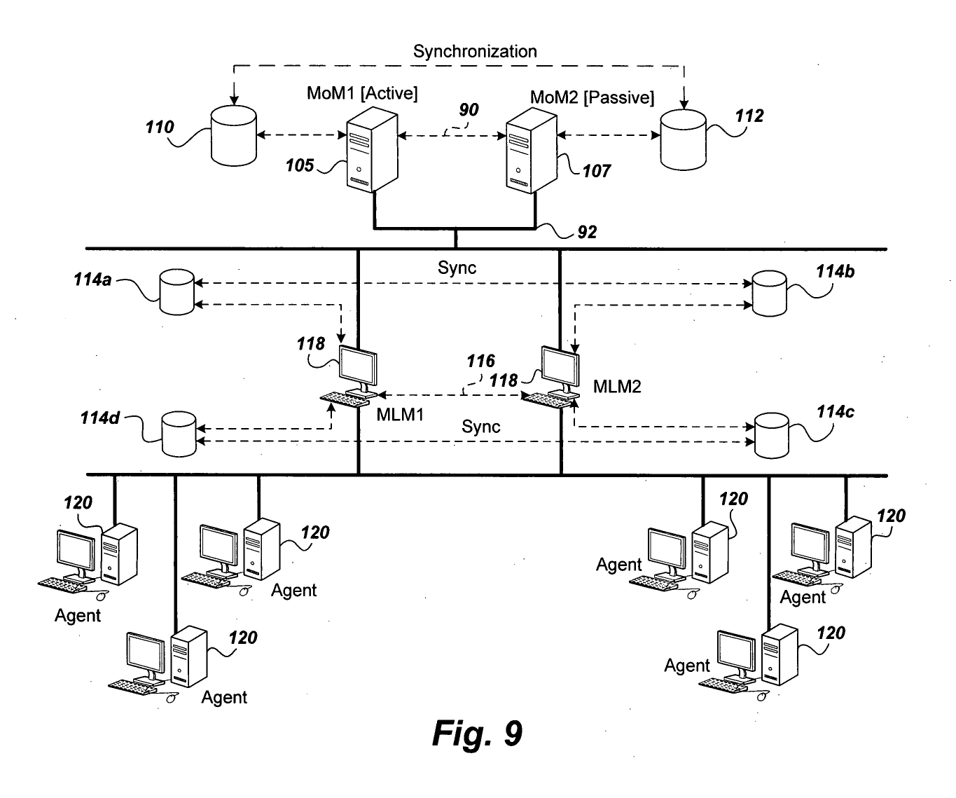

When an MLM fails, its partner MLM detects the failure through the heartbeats 116 and initializes the takeover procedure. The procedure includes assuming the IP of the failed MLM and checking any incomplete operations. During the failure of the MLM, the partner continues to incorporate the state information pertaining to nodes under the supervision of the failed MLM into the copy of the database of the failed MLM. This guarantees that the database of the failed MLM is kept up-to-date and consistent with the actual network state. This also allows the active MoM and the network administrator to continue accessing the database of the failed MLM even when this latter is down, thus increasing the system availability. As shown in FIG. 9, synchronization of logical databases could be accomplished via dual pairs of physical databases, i.e., mass storage devices 114a, 114b, 114d, 114c.

Load sharing is functionality that can be easily adopted in the architecture of the FTNMS 10. This can be achieved by assigning half of the agents of one sub-group to one MLM, and the other half to the other MLM. If this is done for all groups in the network, then the load will be distributed among each MLM pair.

It is to be understood that the present invention is not limited to the embodiment described above, but encompasses any and all embodiments within the scope of the following claims.

We claim:

1. A fault-tolerant network management system (FTNMS), comprising:
an active Manager-of-Managers (MoM);
a passive Manager-of Managers (MoM), the MoMs being in a top tier;
a plurality of pairs of Mid-Level Managers (MLMs), the pairs of MLMs being in a middle tier;
and a plurality of agents, the plurality of agents being in a bottom tier of a three-layer hierarchical arrangement within the system;
means for determining when a given manager ceases to operate; and
means for dynamic reconfiguration of managers within the hierarchy to assume the responsibility of the non-operating manager.

2. The fault-tolerant network management system according to claim 1, further comprising MoM and MLM roles controlled by an administrator.

3. The fault-tolerant network management system according to claim 1, further comprising a fully functioning hot sparing MLM pair arranged in an active/active scheme.

4. The fault-tolerant network management system according to claim 1, further comprising a floating MLM IP address arrangement facilitating MLM IP identity preservation.

5. The fault-tolerant network management system according to claim 1, further comprising MoMs configured in a hot standby sparing active-passive mode.

6. The fault-tolerant network management system according to claim 5, further comprising a heartbeat arrangement fully synchronizing said pair of MoMs, thereby reducing transition time upon NMS failure.

7. The fault-tolerant network management system according to claim 1, further comprising a virtual IP arrangement facilitating transparent identity of MoMs.

8. The fault-tolerant network management system according to claim 1, further comprising means for data retransmission during failover.

9. The fault-tolerant network management system according to claim 1, further comprising an operations log facilitating completion of transactions when a failure occurs without human intervention and without loss of management information during the failover.

10. The fault-tolerant network management system according to claim 1, further comprising two fully synchronized databases at the MoM level of said hierarchy, one of the databases at each of the MoMs.

11. The fault-tolerant network management system according to claim 10, further comprising means for updating said databases only through said active MoM.

12. The fault-tolerant network management system according to claim 10, further comprising means for synchronizing said two databases on said active MoM and on said passive MoM.

13. The fault-tolerant network management system according to claim 10, further comprising first and second databases in each MLM, said first database being a native database, and said second database being a copy of a partner MLM.

14. The fault-tolerant network management system according to claim 13, wherein said databases are distributed and redundant.
